(19) United States
(12) Patent Application Publication
(10) Pub. No.: US 2004/0241319 A1
(43) Pub. Date: Dec. 2, 2004

(54) Method of manufacturing phase-difference film using polarized ultraviolet light

(75) Inventors: Un Nyoung Sa, Gyeonggi-do (KR); Man Hoan Lee, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/855,363

(22) Filed: May 28, 2004

(30) Foreign Application Priority Data
May 30, 2003 (KR) 34584/2003

(51) Int. Cl. B05D 1/36

(52) U.S. Cl. 427/162; 427/402; 427/558

(57) ABSTRACT

A method of manufacturing a phase-difference film includes printing and hardening an alignment film on a substrate, coating a liquid crystal material on the hardened alignment film, and irradiating polarized ultraviolet light on the coated liquid crystal material to control an alignment direction of the liquid crystal material.

The present invention claims the benefit of Korean Patent Application No. 34584/2003 filed in Korea on May 30, 2003, which is hereby incorporated by reference.

### BACKGROUND OF THE INVENTION

1. Field of the Invention

The present invention relates to a liquid crystal display, and more particularly, to a method of manufacturing a phase-difference film using polarized ultraviolet light in which an alignment direction of liquid crystal material is determined without a rubbing process of the phase-difference film.

2. Description of the Related Art

Recently, many efforts have been made to study and develop flat display panels having slim thickness, light weight and low power consumption. Liquid crystal display (LCD) devices, a type of flat display panels, have been applied in and incorporated into various portable electronic equipment including portable phones, computer monitors, television sets and personal data assistants devices (PDAs), because of their high quality image, lightness, small thickness, compact size and low power consumption.

In general, a liquid crystal display device includes two substrates having electric-field generation electrodes formed thereon. The two substrates are arranged to face each other with a predetermined space therebetween and liquid crystal material is injected between the two substrates.

The liquid crystal display device uses optical anisotropy and polarization properties of liquid crystal molecules to produce an image. For instance, the orientation of the liquid crystal molecules can be aligned in a specific direction controlled by an electric field induced by applying a voltage to the electric-field generation electrodes. As the applied electric field changes, so does the alignment of the liquid crystal molecules. Due to the optical anisotropy of the liquid crystal, the refraction of incident light on the liquid crystal molecules also changes depending on the alignment direction of the liquid crystal molecules. Thus, by properly controlling an electric field applied to a group of liquid crystal molecules in respective pixels of a liquid crystal display device, a desired image can be produced by diffracting light.

In addition, the anisotropy of a liquid crystal layer/cell changes depending on a distribution degree of the liquid crystal molecules formed therein and a distribution degree of tilt angles with respect to the substrate. Due to such a property of the liquid crystal molecules, polarization changes depending on a viewing angle of the liquid crystal layer/cell. Thus, a luminance and a contrast ratio of a LCD panel change depending on omni-directional viewing angles. Therefore, the LCDs have problems with obtaining a constant luminance and a constant contrast ratio.

To overcome the foregoing problems, a compensate film has been proposed. In the compensate film, a phase difference with respect to a transmitted light is varied by a polymer film. Also, the compensate film is extended in a predetermined direction to have birefringence due to anisotropic induction of the molecule. For example, when an electric field is applied to a twisted nematic (TN) mode liquid crystal display having a normally black mode, the liquid crystal molecules respond to the applied electric field and generate light transmittance in a manner shown by the following equation:

I=Io sin²[θ(1+u²)1/2],

where u=πR/θλ, R=Δn·d, I referring to an intensity of a transmitted light, Io referring to an intensity of an incident light, Δn referring to a birefringence, d referring to a thickness of a liquid crystal cell, λ referring to a wavelength of a transmitted light, θ referring to a twist angle of a TN liquid crystal, and R referring to a phase difference. Thus, light transmitting in a vertical direction and light transmitting in an oblique direction have different phrases. In other words, characteristic of the transmitted light changes depending on the viewing angle.

The birefringence value (Δn·d) of the light transmitting through the liquid crystal cell is evaluated by multiplying a difference value of refractive index on a plane perpendicular to a light forwarding direction by a thickness of the liquid crystal cell. Thus, the compensate film includes a liquid crystal layer designed to have the birefringence almost identical with the birefringence (d*(ne-no)) of the liquid crystal and to have a negative phase value (ne-no) so as to compensate the liquid crystal for the phase difference, thereby compensating for the viewing angle.

As shown in the above equation, since the phase difference is intimately related to the viewing angle, it is desirable that compensation is performed for the phase difference to improve the viewing angle. Accordingly, the compensate film formed between a liquid crystal substrate and a polarizer film is provided with a uniaxial refractive-index anisotropic body and a biaxial refractive-index anisotropic body so as to compensate for the phase difference.

FIGS. 1A to 1C are schematic views illustrating a refractive-index anisotropic ellipsoid of a phase-difference compensate film. In FIGS. 1A to 1C, X-, Y-, and Z-direction refractive indices are respectively expressed as “nₓ”, “n_{y}” and “n_{z}” Uniaxiality and biaxiality are determined depending on whether or not the X-direction refractive index “nₓ” is identical with the Y-direction refractive index “n_{y}”. In FIG. 1A, the uniaxiality refers to a case where refractive indices of two directions (X- and Y-directions) are equal to each other but different from a refractive index of the remaining direction (Z-direction). In FIGS. 1B and 1C, the biaxiality refers to a case where refractive indices of three directions (X-, Y- and Z-directions) are different from one another. A phase-difference film using the uniaxial refractive-index anisotropic body is typically aligned such that a long axis of the ellipsoid is parallel to and vertical with the surface of the phase-difference film.

FIG. 2 is a schematic view of a method of manufacturing a phase-difference film using an extension method according to the related art. In FIG. 2, a polymer film 1 is uniaxially or biaxially extended by the extension method. For example, the extension ratios are differentiated at left and right sides of the polymer film 1 to change a light axial direction of the resultant phase-difference film. That is, the light axis has the same direction or a vertical direction with respect to an extension direction, thereby allowing the light axis of the phase-difference film to have a predetermined angle with respect to a film forwarding direction to obtain a desired birefringence. Accordingly, in order to use the phase-difference film for optic compensation of the liquid crystal display, the manufactured phase-difference film should be cut to allow the light axis of the phase-difference film to have a predetermined angle with respect to the light axis of the polarizer film.

However, in the extension method, it is difficult to obtain a desired angle due to a mechanical control of the extension ratio. Further, since the phrase-difference film should be attached sheet by sheet to the polarizer film, a production efficiency is lower and there is a risk of introducing foreign-substance between the sheets. Accordingly, a recent study has been made for a coatable retarder where the compensate film is directly formed on a glass substrate in a manufacture process, rather than an external-attached compensate film.

FIGS. 3A to 3E are diagrams illustrating a method of manufacturing a phase-difference film according to the related art. In FIG. 3A, an organic polymer along with a solvent is coated on a substrate 2 to form a layer 3. After the solvent is removed from the resultant layer at a temperature of 60-80° C., the coated layer 3 is hardened at a temperature of 80-200° C. to form an alignment layer 3′. The organic polymer includes a polyimide-based organic material.

In FIG. 3B, a roller 4 having a rubbing material is used to rub the alignment layer 3′ in a predetermined direction. The roller 4 has velvet or the like wound therearound, thereby forming various alignment patterns as it is rolled over the alignment layer 3′. This rubbing method is appropriate for mass production, because it provides an easy and stable alignment and is easy to control a pre-tilt angle.

In FIG. 3C, after the rubbing process, a cleaning process is performed to clean the surface of the alignment film 3′ and to remove any particles left from the rubbing material, thereby preventing the cell from being polluted with foreign particles.

In FIG. 3D, a light hardening liquid crystal material 5 is coated on the alignment film 3′. For example, the light hardening liquid crystal material 5 has 5 w% concentration of a photo initiator (IG184, Ciba-Geigy) and a hardening nematic liquid crystal mixed with 3-penthanon to prepare a solution with a concentration of 10 wt% or more, particularly, 15-30 w%.

In FIG. 3E, after the substrate is dried at a temperature of above 70° C., particularly at a temperature of 75-90° C., the liquid crystal layer 5′ is further hardened using a nonpolarized ultraviolet light to be adhered as a film.

The above manufactured phase-difference film has the same refractive index distribution as the liquid crystal molecule since the nematic liquid crystal is all aligned in the same direction as that of the alignment film. However, the above-mentioned related art method is difficult to control the alignment direction since the alignment direction of the retarder is determined by the rubbing direction, and particularly, it is difficult to align the retarder since the retarder is distinguished by a unit of a pixel or sub-pixel region. Further, this process is complex including additional processes such as the rubbing process for the alignment of the liquid crystal and the cleaning process are required after the alignment film is printed.

### SUMMARY OF THE INVENTION

Accordingly, the present invention is directed to a method of manufacturing a phase-difference film using polarized ultraviolet light that substantially obviates one or more of the problems due to limitations and disadvantages of the related art

An object of the present invention is to provide a method of manufacturing a phase-difference film and determining an alignment direction of liquid crystal material without a rubbing process of the phase-difference film.

Another object of the present invention is to provide a method of manufacturing a phase-difference film by irradiating polarized ultraviolet light on a liquid crystal material to determine an alignment direction of the liquid crystal material and to concurrently harden the liquid crystal material.

Yet, another object of the present invention is to provide a method of manufacturing a phase-difference film having more than one alignment direction using polarized ultraviolet light.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method of manufacturing a phase-difference film includes printing and hardening an alignment film on a substrate, coating a liquid crystal material on the hardened alignment film, and irradiating polarized ultraviolet light on the coated liquid crystal material to control an alignment direction of the liquid crystal material.

In another aspect of the present invention, there is provided the method of manufacturing a phase-difference film includes printing and hardening an alignment film on a substrate, coating a liquid crystal material on the hardened alignment film, and irradiating polarized ultraviolet light on the coated liquid crystal material using a patterned mask to control an alignment direction of the liquid crystal material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1A to 1C are schematic views illustrating a refractive-index anisotropic ellipsoid of a phase-difference compensate film;

FIG. 2 is a schematic view of a method of manufacturing a phase-difference film using an extension method according to the related art;

FIGS. 3A to 3E are diagrams illustrating a method of manufacturing a phase-difference film according to the related art;

FIGS. 4A to 4C are diagrams illustrating a method of manufacturing a phase-difference film according to an embodiment; and

FIGS. 5A to 5C are diagrams illustrating a method of manufacturing a phase-difference film according to another embodiment.

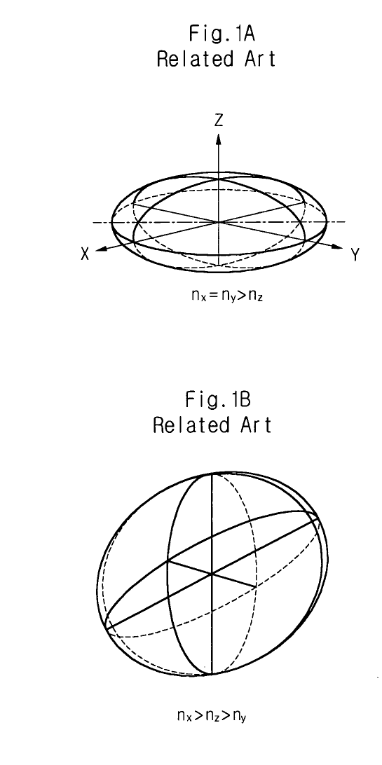

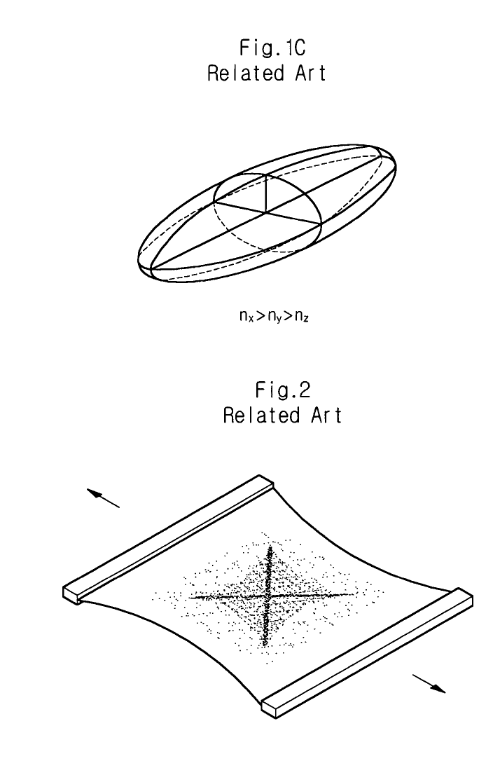

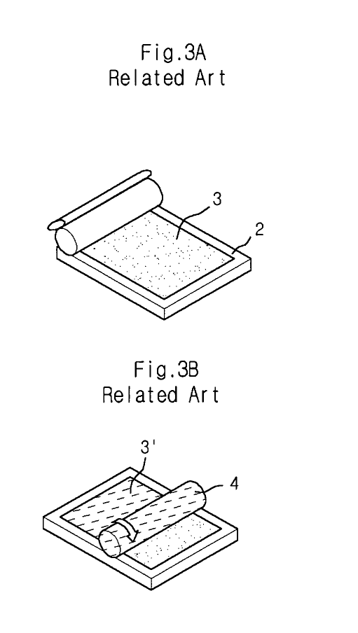

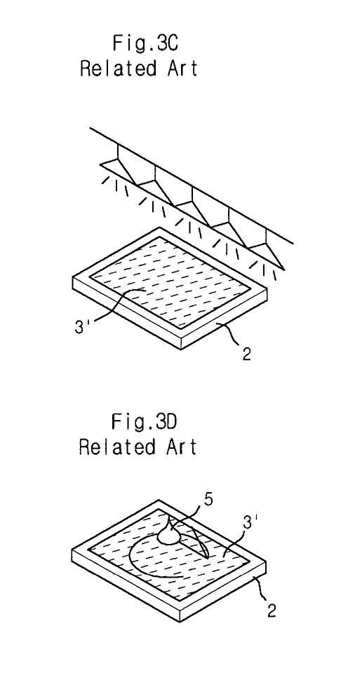

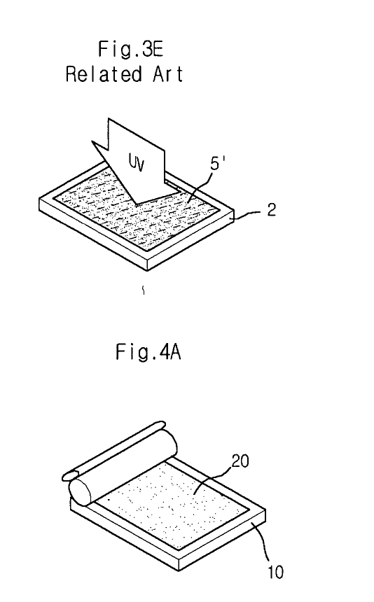

### DETAILED DESCRIPTION OF THE PREFERRED EMBODIMENT

Reference will now be made in detail to the preferred embodiments, examples of which are illustrated in the accompanying drawings.

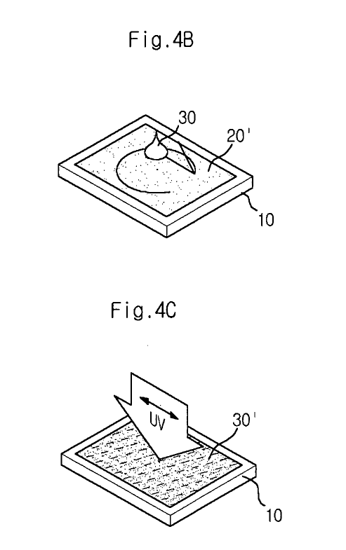

FIGS. 4A to 4C are diagrams illustrating a method of manufacturing a phase-difference film according to an embodiment. In FIG. 4A, a polymer may be coated on a substrate 10, thereby forming an alignment film 20 for aligning liquid crystal molecules in a predetermined direction. The alignment film 20 may include an organic polymer, such as a polyimide-based organic material. The alignment film 20 may be coated at a temperature of about 60-80° C., and the coated alignment film may be hardened at a temperature of about 80-200° C.

In FIG. 4B, a liquid crystal material 30 may be coated on the hardened alignment film 20′. The liquid crystal material 30 may be a hardening liquid crystal material having a hardening reactor. The hardening reactor may be formed of a uniaxial or biaxial material, and may react to polarized ultraviolet light. A nematic or discotic liquid crystal may be used as the liquid crystal material 30. When the nematic liquid crystal is used, about 5 w % concentration of a photo initiator (IG184, Ciba-Geigy) and a hardening nematic liquid crystal may preferably be mixed with 3-penthanon to prepare a solution with a concentration of about 10 wt % or more, such as about 15-30 w %. Then, such a prepared solution may be coated on the hardened alignment film 20′.

In FIG. 4C, polarized ultraviolet (UV) light may be irradiated on the coated liquid crystal material 30′, thereby hardening the coated liquid crystal material 30′ and forming a film. For example, a light source (not shown) may irradiate non-polarized UV light through a polarizer film (not shown) to provide polarized UV light. The polarized UV light may then be irradiated on the coated liquid crystal material 30′.

The irradiation direction and angle of the polarized UV light may control an alignment direction of the liquid crystal materials, thereby forming a phase-difference film. Thus, if the liquid crystal materials to be injected into a liquid crystal panel having the substrate 10 thereof are aligned in the same direction as the alignment film, the phase-difference film may have the same refractive index distribution as the liquid crystal materials. If the liquid crystal materials have the birefringence of Δn=0.133, the phase-difference film may also have the measured birefringence of Δn=0.133, which is substantially identical to the birefringence of the liquid crystal materials.

Further, the phase-difference film may have a different retardation depending on a thickness of the coated liquid crystal material 30′. For example, if the coated liquid crystal material 30′ has a thickness of about 0.8-1.5 μm, a λ/4 phase-difference film functioning at a visible light region may be obtained. Accordingly, the phase-difference film with the coated nematic liquid crystal being controlled in thickness has a retardation range of about 50-400 nm.

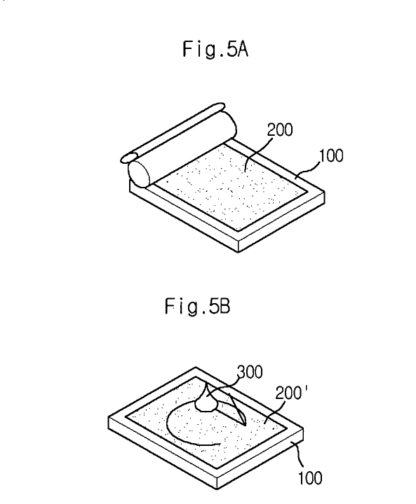

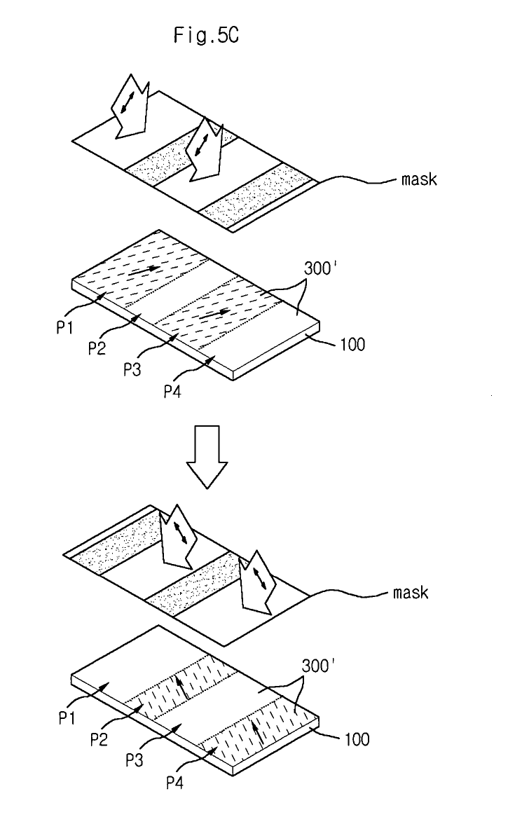

FIGS. 5A to 5C are diagrams illustrating a method of manufacturing a phase-difference film according to another embodiment. In FIG. 5A, a polymer may be coated on a substrate 100, thereby forming an alignment film 200 for aligning liquid crystal molecules in a predetermined direction. The alignment film 200 may include an organic polymer, such as a polyimide-based organic material. The alignment film 200 may be coated at a temperature of about 60-80° C., and the coated alignment film may be harden at a temperature of about 80-200° C.

In FIG. 5B, a liquid crystal material 300 may be coated on the hardened alignment film 200′. The liquid crystal material 300 may be a hardening liquid crystal material having a hardening reactor. The hardening reactor may be formed of a uniaxial or biaxial material, and may react to polarized ultraviolet light. A nematic or discotic liquid crystal may be used as the liquid crystal material 300. When the nematic liquid crystal is used, about 5 w % concentration of a photo initiator (IG184, Ciba-Geigy) and a hardening nematic liquid crystal may preferably be mixed with 3-penthanon to prepare a solution with a concentration of about 10 wt % or more, such as 15-30 w %. Then, such prepared solution may be coated on the hardened alignment film 200′.

In FIG. 5C, polarized ultraviolet (UV) light may be irradiated on the coated liquid crystal material 300′, thereby hardening the coated liquid crystal material 300′ and forming a film. In addition, a patterned mask may be used to control an irradiation direction and an angle of the polarized UV light, thereby determining an alignment direction of the liquid crystal material. For example, a light source (not shown) may irradiate non-polarized UV light through a polarizer film (not shown) to provide polarized UV light. The polarized UV light may further pass through the patterned mask. Further, the patterned mask may include more than one mask designed to allow the polarized UV light to have a different irradiation direction in each pixel region (P1, P2, P3 and P4)of the substrate 100, thereby aligning the liquid crystal materials in the pixel regions differently. Accordingly, the alignment direction can be more easily controlled to form a complex-configured phase-difference film.

If the liquid crystal materials to be injected into a liquid crystal panel having the substrate 100 thereof are aligned in more than one direction, thereby forming more than one refractive indices, the alignment direction of the liquid crystal material of the phase-difference film may be determined using the polarized ultraviolet light, thereby providing its dependent refractive index.

In addition, if the liquid crystal materials to be injected into the liquid crystal panel have the birefringence of about Δn=0.133, the manufactured phase-difference film also may have the measured birefringence of about Δn=0.133, which is substantially identical to the birefringence of the liquid crystal materials.

Further, the phase-difference film has a different retardation depending on a thickness of the coated liquid crystal material. In case that the liquid crystal material is coated to have a thickness of 0.8-1.5 μm, a λ/4 phase-difference film functioning at a visible light region is obtained. At this time, the phase-difference film with the coated nematic liquid crystal being controlled in thickness has a retardation range of 50-400 nm.

Accordingly, since the method of manufacturing the phase-difference film using the polarized ultraviolet light not only easily determines the alignment direction of the liquid crystal material, but also performs such an alignment direction control without separate rubbing and cleaning processes, thereby reducing production time and improving fabrication yield.

The above-described embodiments can irradiate polarized ultraviolet light to the coated liquid crystal material without the rubbing process for the alignment film, thereby crystallizing the alignment direction of the liquid crystal material in the predetermined direction. Further, the above-described embodiments can determine the alignment direction of the liquid crystal material and concurrently harden the liquid crystal material.

It will be apparent to those skilled in the art that various modifications and variations can be made in the method for manufacturing a phase-difference film of the present invention without departing from the spirit or scope of the invention. Thus, it is intended that the present invention cover the modifications and variations of this invention provided they come within the scope of the appended claims and their equivalents.

What is claimed is:

1. A method of manufacturing a phase-difference film, comprising:
printing and hardening an alignment film on a substrate;
coating a liquid crystal material on the hardened alignment film; and
irradiating polarized ultraviolet light on the coated liquid crystal material to control an alignment direction of the liquid crystal material.

2. The method according to claim 1, wherein the alignment direction is determined based on an irradiation direction of the polarized ultraviolet light irradiated on the liquid crystal material.

3. The method according to claim 1, wherein the alignment film includes an organic material.

4. The method according to claim 1, wherein the liquid crystal material coated on the alignment film includes a hardening liquid crystal material, the hardening liquid crystal material including a hardening reactor formed of a uniaxial or biaxial material, the hardening reactor reacting to the polarized ultraviolet light.

5. The method according to claim 1, wherein the liquid crystal material includes nematic liquid crystals.

6. The method according to claim 1, wherein the liquid crystal material includes discotic liquid crystals.

7. A method of manufacturing a phase-difference film, comprising:
printing and hardening an alignment film on a substrate;
coating a liquid crystal material on the hardened alignment film; and
irradiating polarized ultraviolet light on the coated liquid crystal material using a patterned mask to control an alignment direction of the liquid crystal material.

8. The method according to claim 7, wherein the polarized ultraviolet light is irradiated using the patterned mask in a different direction every pixel region to determine the alignment direction of the liquid crystal material.

9. The method according to claim 7, wherein the alignment film includes an organic material.

10. The method according to claim 7, wherein the liquid crystal material coated on the alignment film includes a hardening liquid crystal material, the hardening liquid crystal material including a hardening reactor formed of a uniaxial or biaxial material, the hardening reactor reacting according to the polarized ultraviolet light.

11. The method according to claim 7, wherein the liquid crystal material includes nematic liquid crystals.

12. The method according to claim 7, wherein the liquid crystal material includes discotic liquid crystals.
